(19) United States
(12) Patent Application Publication
(10) Pub. No.: US 2026/0325964 A1
(43) Pub. Date: Oct. 22, 2026

(54) HUMAN-MACHINE INTERACTION METHOD AND APPARATUS FOR VIRTUAL CHARACTER, DEVICE, AND STORAGE MEDIUM

(71) Applicant: Tencent Technology (Shenzhen) Company Limited, Shenzhen (CN)

(72) Inventor: Yichen GE, Shenzhen (CN)

(21) Appl. No.: 19/715,372

(22) Filed: Jun. 22, 2026

Related U.S. Application Data
(63) Continuation of application No. PCT/CN2025/084702, filed on Mar. 25, 2025.

(30) Foreign Application Priority Data
May 8, 2024 (CN) 202410566355.0

(51) Int. Cl. A63F 13/52; A63F 13/533; A63F 13/54; A63F 13/79; A63F 13/837

(52) U.S. Cl. CPC A63F 13/52; A63F 13/533; A63F 13/54; A63F 13/79; A63F 13/837

(57) ABSTRACT

A human-machine interaction method is performed by a computer device. The method includes: displaying an observation picture of a virtual environment; playing an environmental sound of a position of a first virtual character in the virtual environment, the environmental sound including a sound of a virtual prop used by the first virtual character; when the environmental sound exceeds a tolerance threshold of the first virtual character, changing the first virtual character from an auditory-normal state to an auditory-impaired state; and displaying a degraded picture of the virtual environment, which simulates an observation result of the virtual environment by the first virtual character that is in the auditory-impaired state, and image quality of the degraded picture being lower than image quality of the observation picture. The auditory-impaired state is simulated through the visual effect and/or the auditory effect, to simulate a decline of a perceptual capability of a physiological organ.

### CROSS-REFERENCE TO RELATED APPLICATIONS

This application is a continuation application of PCT Patent Application No. PCT/CN2025/084702, entitled “HUMAN-MACHINE INTERACTION METHOD AND APPARATUS FOR VIRTUAL CHARACTER, DEVICE, AND STORAGE MEDIUM” filed on Mar. 25, 2025, which claims priority to Chinese Patent Application No. 202410566355.0, entitled “HUMAN-MACHINE INTERACTION METHOD AND APPARATUS FOR VIRTUAL CHARACTER, DEVICE, AND STORAGE MEDIUM” filed on May 8, 2024, both of which are incorporated herein by reference in their entirety.

### FIELD OF THE TECHNOLOGY

This application relates to the field of human-machine interaction technologies, and in particular, to a human-machine interaction method and apparatus for a virtual character, a device, and a storage medium.

### BACKGROUND OF THE DISCLOSURE

In an application program providing a virtual environment, a virtual character usually needs to be controlled to perform an activity in the virtual environment, such as walking, driving, climbing, picking up items, or battling.

In the related art, the virtual character performs the virtual activity in the virtual environment, to implement a virtual competition.

However, in the related art, when the virtual competition is performed, a stable state of the virtual character leads to a lack of immersive feelings in the virtual environment. How to enhance the immersive feelings of the virtual environment is a problem urgently to be resolved.

### SUMMARY

This application provides a human-machine interaction method and apparatus for a virtual character, a device, and a storage medium, and technical solutions are as follows:

According to an aspect of this application, a human-machine interaction method is performed by a computer device, and the method including: displaying an observation picture of a virtual environment; playing an environmental sound of a position of a first virtual character in the virtual environment, the environmental sound including a sound of a virtual prop used by the first virtual character; when the environmental sound exceeds a tolerance threshold of the first virtual character, changing the first virtual character from an auditory-normal state to an auditory-impaired state; and displaying a degraded picture of the virtual environment, the degraded picture being an observation result of the virtual environment by the first virtual character that is in the auditory-impaired state, and image quality of the degraded picture being lower than image quality of the observation picture.

According to another aspect of this application, a computer device is provided, the computer device including a processor and a memory, the memory having at least one instruction, at least one program, a code set, or an instruction set stored therein, and the at least one instruction, the at least one program, the code set, or the instruction set being loaded and executed by the processor to implement a human-machine interaction method according to the foregoing aspects.

According to another aspect of this application, a non-transitory computer-readable storage medium is provided, the readable storage medium having at least one instruction, at least one program, a code set, or an instruction set stored therein, and the at least one instruction, the at least one program, the code set, or the instruction set being loaded and executed by a processor of a computer device to implement a human-machine interaction method according to the foregoing aspects.

The technical solutions provided in this application have at least the following beneficial effects:

When the environmental sound exceeds the tolerance threshold of the first virtual character, because the first virtual character is stimulated by a sound in the virtual environment and the sound exceeds a tolerance capability of the first virtual character, the first virtual character is in the auditory-impaired state. In this application, the auditory-impaired state is presented through the visual effect and/or the auditory effect. When the auditory-impaired state is presented through the visual effect, the terminal displays a picture to which a negative effect is applied, to reduce information quality presented in a visual manner. When the auditory-impaired state is presented through the auditory effect, the terminal plays an audio to which a negative effect is applied, to reduce information quality presented in an auditory manner. The auditory-impaired state is presented through the visual effect and/or the auditory effect, to negatively affect information in the virtual environment that is obtained in a human-machine interaction manner. In this way, a real-world state in which a perceptual capability of a physiological organ declines after being stimulated by a sound can be simulated, thereby enhancing immersive feelings of the virtual environment.

### BRIEF DESCRIPTION OF THE DRAWINGS

FIG. 1 is a schematic diagram of a computer system according to an exemplary embodiment of this application.

FIG. 2 is a schematic diagram of a human-machine interaction method for a virtual character according to an exemplary embodiment of this application.

FIG. 3 is a flowchart of a human-machine interaction method for a virtual character according to an exemplary embodiment of this application.

FIG. 4 is a flowchart of a human-machine interaction method for a virtual character according to an exemplary embodiment of this application.

FIG. 5 is a schematic diagram of a picture according to an exemplary embodiment of this application.

FIG. 6 is a flowchart of a human-machine interaction method for a virtual character according to an exemplary embodiment of this application.

FIG. 7 is a flowchart of a human-machine interaction method for a virtual character according to an exemplary embodiment of this application.

FIG. 8 is a schematic diagram of a virtual hearing value according to an exemplary embodiment of this application.

FIG. 9 is a flowchart of a human-machine interaction method for a virtual character according to an exemplary embodiment of this application.

FIG. 10 is a flowchart of a human-machine interaction method for a virtual character according to an exemplary embodiment of this application.

FIG. 11 is a schematic diagram of a virtual environment according to an exemplary embodiment of this application.

FIG. 12 is a block diagram of a structure of a human-machine interaction apparatus for a virtual character according to an exemplary embodiment of this application.

FIG. 13 is a block diagram of a structure of a terminal according to an exemplary embodiment of this application.

### DESCRIPTION OF EMBODIMENTS

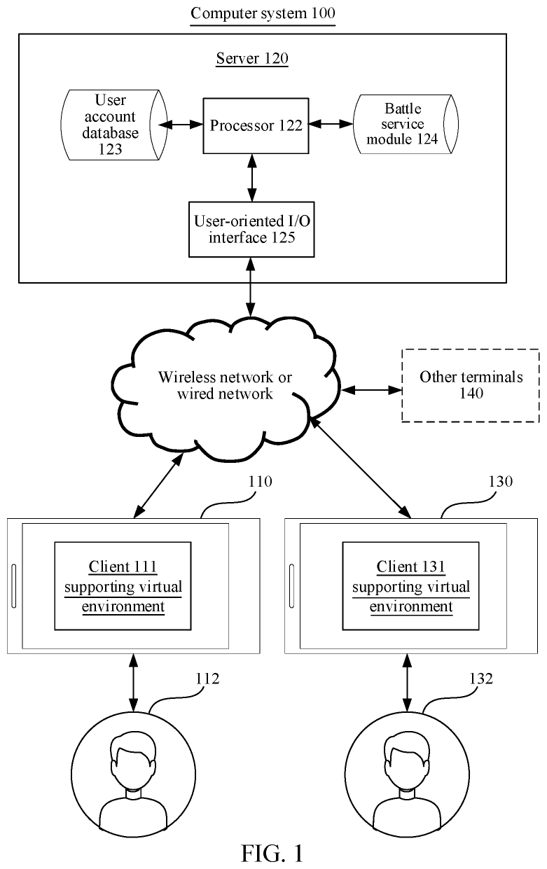

FIG. 1 is a schematic diagram of a computer system according to an exemplary embodiment of this application. A computer system 100 includes: a first terminal 110, a server 120, and a second terminal 130.

A client 111 supporting a virtual environment is installed and run on the first terminal 110. The client 111 may be a multiplayer online battle program. When the first terminal runs the client 111, a user interface of the client 111 is displayed on a screen of the first terminal 110. The client 111 may be any one of a battle royale shooting game, a virtual reality (VR) application program, an augmented reality (AR) program, a three-dimensional map program, a virtual reality game, an augmented reality game, a casual game, a party game, a first-person shooting game (FPS), a third-person shooting game (TPS), a multiplayer online battle arena game (MOBA), or a simulation game (SLG). In this embodiment, an example in which the client 111 is the FPS game is used for description. The first terminal 110 is a terminal used by a first user 112. The first user 112 uses the first terminal 110 to control a first virtual character located in the virtual environment to perform an activity. The first virtual character may be referred to as a virtual character of the first user 112. The activity of the first virtual character includes, but is not limited to, at least one of moving, jumping, teleporting, casting a skill, using a prop, adjusting a body pose, crawling, walking, running, riding, flying, jumping, driving, picking, shooting, attacking, or throwing. Exemplarily, the first virtual character is at least one of a simulated human character, an animated human character, a virtual animal, and a virtual plant.

A client 131 supporting a virtual environment is installed and run on the second terminal 130. The client 131 may be a multiplayer online battle program. When the second terminal 130 runs the client 131, a user interface of the client 131 is displayed on a screen of the second terminal 130. The client may be any one of a battle royale shooting game, a VR application program, an AR program, a three-dimensional map program, a virtual reality game, an augmented reality game, an FPS, a TPS, a MOBA, or an SLG. In this embodiment, an example in which the client is the MOBA game is used for description. The second terminal 130 is a terminal used by a second user 132. The second user 132 uses the second terminal 130 to control a second virtual character located in the virtual environment to perform an activity. The second virtual character may be referred to as a virtual character of the second user 132. Similarly, the second virtual character is at least one of a simulated human character, an animated human character, a virtual animal, and a virtual plant.

In some embodiments, the first virtual character and the second virtual character are located in the same virtual environment. In some embodiments, the first virtual character and the second virtual character may belong to the same camp, the same team, the same organization, have a friend relationship, or have a temporary communication permission. In some embodiments, the first virtual character and the second virtual character may belong to different camps, different teams, different organizations, or have an enemy relationship.

In some embodiments, the clients installed on the first terminal 110 and the second terminal 130 are the same, or the clients installed on the two terminals are the same type of clients on different operating system platforms (Android or iOS). The first terminal 110 may generally refer to one of a plurality of terminals, and the second terminal 130 may generally refer to another one of the plurality of terminals. In this embodiment, only the first terminal 110 and the second terminal 130 are used as an example. A device type of the first terminal 110 and a device type of the second terminal 130 may be the same or may be different. The device type includes at least one of a smartphone, a tablet computer, an e-book reader, an MP3 player, an MP4 player, a laptop portable computer, and a desktop computer.

FIG. 1 only shows two terminals. However, there are a plurality of other terminals 140 that can access the server 120 in different embodiments. In some embodiments, there are also one or more terminals 140 that correspond to a developer. A development and editing platform of a client supporting a virtual environment is installed on the terminal 140. The developer may edit and update the client on the terminal 140, and transmits an installation package of the updated client to the server 120 through a wired or wireless network. The first terminal 110 and the second terminal 130 may download the installation package of the client from the server 120 to update the client. The first terminal 110, the second terminal 130, and the other terminals 140 are connected to the server 120 through the wired or wireless network.

The server 120 includes at least one of one server, a plurality of servers, a cloud computing platform, and a virtualization center. The server 120 is configured to provide a backend serve for a client supporting a three-dimensional virtual environment. In some embodiments, the server 120 is responsible for primary computing work, and the terminal is responsible for secondary computing work; or the server 120 is responsible for secondary computing work, and the terminal is responsible for primary computing work; or a distributed computing architecture is adopted between the server 120 and the terminal to perform collaborative computing.

In an exemplary example, the server 120 includes a processor 122, a user account database 123, a battle service module 124, and a user-oriented input/output interface (I/O interface) 125. The processor 122 is configured to load instructions stored in the server 120, and process data in the user account database 123 and data in the battle service module 124. The user account database 123 is configured to store data of user accounts used by the first terminal 110, the second terminal 130, and the other terminals 140, such as avatars of the user accounts, nicknames of the user accounts, fighting power indexes of the user accounts, and service areas of the user accounts. The battle service module 124 is configured to provide a plurality of battle rooms for users to battle, for example, a 1V1 battle room, a 3V3 battle room, and a 5V5 battle room. The user-oriented I/O interface 125 is configured to establish communication with the first terminal 110 and/or the second terminal 130 through a wireless network or a wired network for data exchange.

The method provided in this application may be but is not limited to being applied to at least one of the following scenarios: a virtual reality application program, a three-dimensional map program, a casual game, a party game, a first-person shooting game (FPS), a third-person shooting game (TPS), a multiplayer online battle arena game (MOBA), a multiplayer gunfight survival game, and the like. The following embodiment is described by using an application in a game as an example.

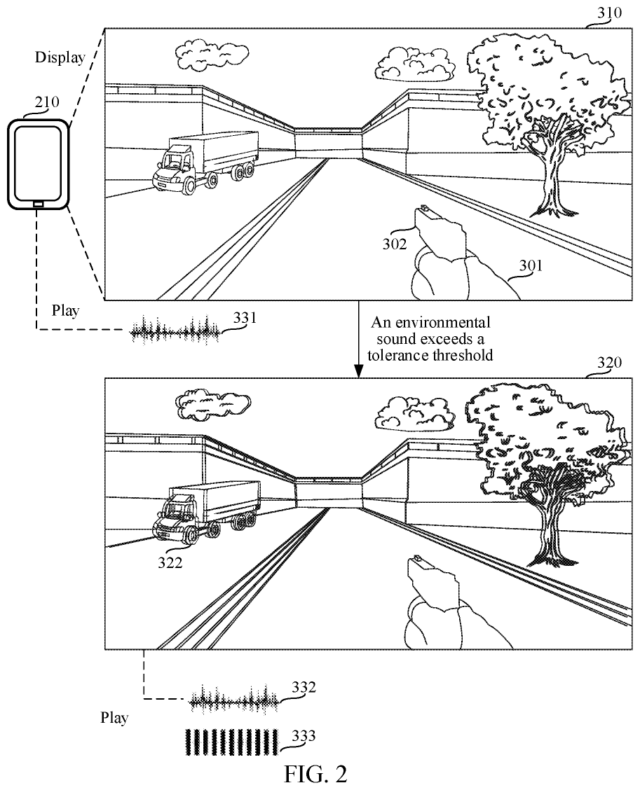

FIG. 2 is a schematic diagram of a human-machine interaction method for a virtual character according to an exemplary embodiment of this application.

A terminal 210 displays a first interface 310, and plays a first audio 331. The terminal 210 is a control terminal of a first virtual character 301. Exemplarily, the terminal 210 may be implemented as any terminal, such as the first terminal 110, in the computer system shown in FIG. 1.

A first-person shooting game is used as an example for description in FIG. 2. The first interface 310 is obtained by observing a virtual environment from a viewing angle of the first virtual character 301. The first interface 310 only displays a hand part of the first virtual character 301, and the first virtual character 301 holds a virtual shooting prop 302. More body parts of the first virtual character 301 may be displayed from a different viewing angle.

The first audio 331 played by the terminal 210 is an environmental sound in the virtual environment. The environmental sound includes a use sound of the virtual shooting prop 302, for example, a firing sound effect of firing the virtual shooting prop 302.

When the virtual shooting prop 302 is fired, the environmental sound exceeds a tolerance threshold, a second interface 320 is displayed, and a second audio 332 and a third audio 333 are played in a superimposed manner.

When the environmental sound exceeds the tolerance threshold of the first virtual character 301, the first virtual character 301 is in an auditory-impaired state. In the auditory-impaired state, the terminal applies a negative effect on information in the virtual environment that is obtained in a human-machine interaction manner, to represent a negative impact caused by the auditory-impaired state on the first virtual character 301.

In the second interface 320, ghosting appears on a virtual item in the virtual environment, and a virtual car 322 is used as an example. In the first interface 310, an edge of the virtual car 322 is clear, and edges of parts such as a cuboid shape of a carriage, a cylindrical shape of a wheel, a car light on a car head, and a license plate are clear. The edge of the virtual car 322 can be clearly identified in the first interface 310, and shapes of all the parts of the car are clearly displayed in the first interface 310.

However, in the second interface 320, ghosting exists on the virtual car 322, and consequently, the real edge of the virtual car 332 cannot be identified. Because the ghosting exists, the shape display of the virtual car 322 is also negatively affected, for example, a car light shape of the virtual car 332 cannot be clearly identified, increasing difficulty in observing a detailed feature of the virtual item, and in terms of a visual effect, increasing difficulty in obtaining the information in the virtual environment that is obtained in the human-machine interaction manner.

The second audio 332 is an environmental sound in the virtual environment at a moment at which the second interface 320 is displayed. The third audio is a noise audio, for example, a buzzing sound. The second audio 332 and the third audio 333 are played in the superimposed manner, and the third audio 333 interferes the second audio 332, in terms of an auditory effect, increasing difficulty in obtaining information in the virtual environment that is obtained in the human-machine interaction manner. The auditory-impaired state is presented through the visual effect and the auditory effect, to reduce an observation effect of the virtual environment by the first virtual character. In this way, a real-world state in which a perceptual capability of a physiological organ declines after being stimulated by a sound can be simulated, thereby enhancing immersive feelings of the virtual environment.

FIG. 3 is a flowchart of a human-machine interaction method for a virtual character according to an exemplary embodiment of this application. The method may be performed by a terminal. The method includes the following operations:

Operation 510: Display an observation picture of a virtual environment.

Exemplarily, the virtual environment is a virtual space in which a first virtual character performs a virtual activity. For example, the first virtual character launches a virtual attack in a virtual battle to implement a virtual competition. The virtual environment may be any one of a two-dimensional virtual environment, a 2.5-dimensional virtual environment, and a three-dimensional virtual environment.

Exemplarily, the observation picture is a picture obtained by observing the virtual environment from a viewing angle of the first virtual character; in some examples, in the virtual environment, the observation picture is obtained by observing the virtual environment through a virtual camera; and correspondingly, the observation picture is obtained by observing the virtual environment through the virtual camera corresponding to the first virtual character, and the virtual camera may observe the virtual environment from perspectives such as a first-person perspective or a third-person perspective, to obtain the observation picture. The observation picture is displayed to a control party (for example, a player user of a game application) of the terminal, to present an observation result of the virtual environment.

In some examples, the terminal performing this embodiment is usually a terminal having a control permission of the first virtual character, but a terminal that is used by a battle spectator that watches the first virtual character performing the virtual activity is not excluded.

Operation 520: Play an environmental sound of a position of the first virtual character in the virtual environment.

The environmental sound includes a sound of a virtual prop used by the first virtual character, and the virtual prop may be carried by the first virtual character or another virtual character in the virtual environment, or may be deployed in the virtual environment for automatic use. This application does not limit ownership and a use manner of the virtual prop.

Exemplarily, the environmental sound played by the terminal is a sound that is propagated to the position of the first virtual character in the virtual environment. Sound propagation in the virtual environment simulates a sound propagation rule in the real world. For example, a sound gradually attenuates in a propagation process, attenuation of the sound gradually decreases with a square of a distance, and an intensity of the sound is inversely proportional to the square of the distance.

Operation 530: When the environmental sound exceeds a tolerance threshold of the first virtual character, change the first virtual character from an auditory-normal state to an auditory-impaired state. when the environmental sound exceeds the tolerance threshold of the first virtual character, the first virtual character is changed to be in the auditory-impaired state. The auditory-impaired state is a state in which a virtual auditory sensation declines because the virtual auditory sensation of the first virtual character is stimulated by the environmental sound and the sound exceeds a tolerance capability of the first virtual character. In the auditory-impaired state, information in the virtual environment that is obtained in a human-machine interaction manner is negatively affected. For example, the auditory-impaired state is presented through the visual effect and/or the auditory effect.

In an example, the first virtual character is in the auditory-impaired state, which is caused because the environmental sound in the virtual environment exceeds the tolerance threshold, and the auditory-impaired state of the first virtual character is not associated with whether the first virtual character is located within an effective range of a virtual prop or a virtual skill. The use sound of the virtual prop included in the environmental sound is an auxiliary representation manner for simulating a sound effect of a corresponding item in the real world when the item is used, rather than an effective effect of the virtual prop. For example, using a virtual shooting prop as an example, a use sound of the virtual shooting prop is configured for simulating a use sound of a shootable implement in the real world, and an effective effect of the virtual shooting prop is virtual damage caused by shooting a virtual bullet, rather than playing the use sound of the virtual shooting prop.

Exemplarily, the visual effect is usually presented through a display screen of the terminal, and the auditory effect is usually played through an audio circuit of the terminal. The auditory-impaired state is presented through the visual effect and the auditory effect, to simulate a real-world state in which a perceptual capability of a physiological organ declines after the auditory sensation receives external stimulation. The auditory-impaired state presented by the visual effect and the auditory-impaired state presented by the auditory effect are described in the following by using separate embodiments.

In conclusion, in the method provided in this embodiment, when the environmental sound exceeds the tolerance threshold of the first virtual character, because the first virtual character is stimulated by the sound in the virtual environment and the sound exceeds a tolerance capability of the first virtual character, the first virtual character is in the auditory-impaired state. In this application, the auditory-impaired state is presented through a visual effect and/or an auditory effect. When the auditory-impaired state is presented through the visual effect, the terminal displays a picture to which a negative effect is applied, to reduce information quality presented in a visual manner. When the auditory-impaired state is presented through the auditory effect, the terminal plays an audio to which a negative effect is applied, to reduce information quality presented in an auditory manner. The auditory-impaired state is presented through the visual effect and/or the auditory effect, to negatively affect the information in the virtual environment that is obtained in the human-machine interaction manner. In this way, a real-world state in which a perceptual capability of a physiological organ declines after being stimulated by a sound can be simulated, thereby enhancing immersive feelings of the virtual environment.

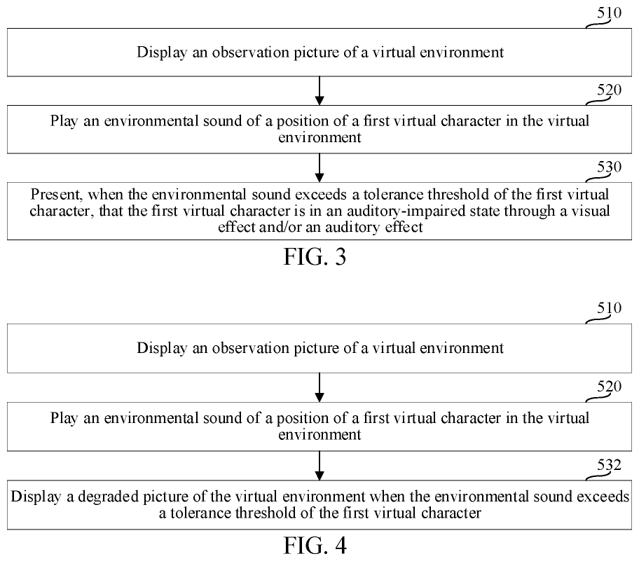

Next, the following two embodiments are used to respectively describe the auditory-impaired state presented through the visual effect and the auditory-impaired state presented through the auditory effect. FIG. 4 is a flowchart of a human-machine interaction method for a virtual character according to an exemplary embodiment of this application. The method may be performed by a terminal. In other words, in the embodiment shown in FIG. 3, operation 530 may be implemented as operation 532.

Operation 532: Display a degraded picture of the virtual environment when the environmental sound exceeds a tolerance threshold of the first virtual character.

At a moment when the environmental sound exceeds the tolerance threshold of the first virtual character, the first virtual character is in an auditory-impaired state. The degraded picture is an observation result of the virtual environment by the first virtual character that is in the auditory-impaired state; and is a display picture of the terminal that is in an auditory-impaired state.

Image quality of the degraded picture is lower than image quality of the observation picture. Image quality includes, but is not limited to, at least one of definition, a color, and a dynamic range. Picture content of the degraded picture is not limited in this embodiment. For example, in response to a move operation on the first virtual character, an observation position of the first virtual character for the virtual environment changes, and picture content in a degraded picture is different from picture content of the observation picture displayed in operation 510.

When the first virtual character is in the auditory-impaired state, the degraded picture with low image quality is displayed, to simulate a real-world state in which a perceptual capability declines after sound stimulation is received. In the auditory-impaired state, information in the virtual environment that is obtained in a visual observation manner is negatively affected.

In an exemplary implementation, the degraded picture of the virtual environment is described as follows. The displaying a degraded picture of a virtual environment may be implemented as at least one of the following:
Displaying that a first region of the degraded picture is blocked.

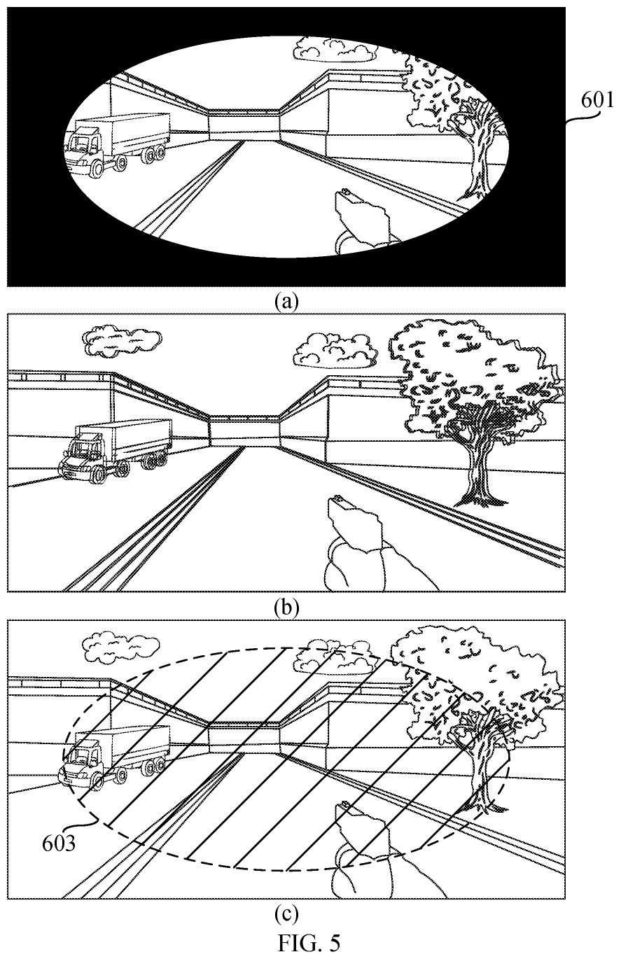

Exemplarily, the first region is some or all regions of the degraded picture, and the first region is usually a region located at an edge part in the degraded picture. The first region is blocked, and an observation result of the virtual environment cannot be presented in the first region. Referring to a sub-figure (a) in FIG. 5, a first region 601 is a region in the sub-figure (a) that is displayed as an all-black part. The first region 601 is located at an edge part of the sub-figure (a). The first region 601 is filled with black, so that an observation result of a virtual environment cannot be presented. Exemplarily, in FIG. 5, displaying the first region 601 in black is merely an exemplary representation, and the first region 601 may alternatively be filled with another non-transparent color.

The first region is blocked, to reduce an observation effect of the virtual environment by the first virtual character in a manner in which an area of a region in the degraded picture that is configured for presenting the observation result of the virtual environment is reduced. In this way, a real-world state in which a perceptual capability of a physiological organ declines after being stimulated by a sound is simulated.
Displaying that ghosting exists on a virtual item located in a second region of the degraded picture.

Similarly, the second region is some or all regions in the degraded picture, and the second region is generally a region located at an edge part in the degraded picture, or a region in which the virtual item exists in the degraded picture. In the second region, the ghosting of the virtual item and the virtual item in the degraded picture overlap with each other, increasing difficulty in determining, by an observer of the degraded picture, an edge position of the virtual item, and difficulty in observing, by the observer of the degraded picture, a detailed feature of the virtual item, thereby reducing the observation effect of the virtual environment by the first virtual character. Referring to a sub-figure (b) in FIG. 5, the second region is an entire region of the sub-figure (b), and the ghosting exists on the virtual item in the sub-figure (b). The ghosting of the virtual car is described in FIG. 2, and details are not described herein again.

The ghosting exists on the virtual item in the second region, which reduces the observation effect of the virtual environment by the first virtual character in a manner in which the difficulty of identifying the virtual item in the degraded picture is increased. In this way, a real-world state in which a perceptual capability of a physiological organ declines after being stimulated by a sound is simulated.
Displaying that a third region of the degraded picture is superimposed with a first color.

Exemplarily, the third region is some or all regions in the degraded picture, and the third region is usually a region that is located in a central position of the degraded picture. In the third region, the first color is superimposed, to increase difficulty in observing a real color of a virtual item in the third region. Further, the first color displayed in the superimposed manner can mask a virtual item in the third region whose real color is similar to the first color, so that difficulty in identifying the virtual item whose real color is similar to the first color is increased.

Exemplarily, the first color may be a preset color, for example, red, and the red color is configured for simulating a real-world state in which a perceptual capability declines because congestion occurs after sound stimulation is received. The first color may alternatively be a color determined in a virtual picture, for example, a color having the largest display area in the observation picture, and the color is configured for simulating a real-world case in which only the color having the largest display area can be recognized because a color perceptual capability declines after sound stimulation is received. Referring to a sub-figure (c) in FIG. 5, a third region 603 is an elliptic region filled with oblique lines that is displayed in the sub-figure (c), and the third region 603 is located in a central part of the sub-figure (c). Exemplarily, a first color of the third region 603 is translucent, so that the first color and the virtual environment can be simultaneously displayed in a superimposed manner. In FIG. 5, the third region is displayed in an ellipse shape. In different implementations, at least one of the first region to a fourth region may be implemented as a rectangle, a trapezoid, a circle, a sector, or a closed shape formed by a plurality of line segments or curves. Shapes of the regions are not limited in this application.

The third region is superimposed with the first color, which reduces the observation effect of the virtual environment by the first virtual character in a manner in which the difficulty of observing the real color of the virtual item in the degraded picture is increased. In this way, a real-world state in which a perceptual capability of a physiological organ declines after being stimulated by a sound is simulated.
Displaying a blur effect in the fourth region of the degraded picture.

Exemplarily, the fourth region is some or all regions in the degraded picture. As described above, the degraded picture may include two or more of the first region to the fourth region at the same time. When the degraded picture includes two or more of the first region to the fourth region at the same time, overlapping parts may exist between different regions. Further, two different regions may be completely the same. For example, either of the third region and the fourth region is an entire part of the degraded picture, that is, the degraded picture is not only superimposed with the first color, but also has the blurring effect displayed therein. This application is not limited thereto.

Exemplarily, in the fourth region, details of the virtual environment cannot be displayed, and information about the virtual environment can be obtained only through a blurred contour and colors with blurred borders after blurring, so that an amount of information about the virtual environment that can be presented in the fourth region is greatly compressed, thereby reducing the observation effect of the virtual environment by the first virtual character. The blur effect displayed in the second region includes, but is not limited to, at least one of Gaussian blurring, average blurring, and bilateral blurring.
Displaying the degraded picture at a first resolution.

Exemplarily, the first resolution is lower than a second resolution of the observation picture. The degraded picture is displayed in a low resolution manner, so that picture details in the degraded picture are lost in a manner of reducing the resolution, and the observation effect of the virtual environment by the first virtual character is reduced in a manner in which details of the picture cannot be observed. In this way, a real-world state in which a perceptual capability of a physiological organ declines after being stimulated by a sound is simulated.

In conclusion, in the method provided in this embodiment, when the environmental sound exceeds a tolerance threshold of the first virtual character, because the first virtual character is stimulated by a sound in the virtual environment and the sound exceeds a tolerance capability of the first virtual character, the first virtual character is in an auditory-impaired state. When the auditory-impaired state is presented through a visual effect, a terminal displays the degraded picture to which the negative effect is applied, to reduce information quality presented in a visual manner in at least one of the following manners: providing a blocking region, providing a ghosting region, superimposing a first color, and displaying a blurring effect. Compared with the observation picture, the degraded picture reduces the observation effect of the virtual environment, and can simulate a real-world state in which a perceptual capability of a physiological organ declines after being stimulated by a sound, thereby enhancing immersive feelings of the virtual environment.

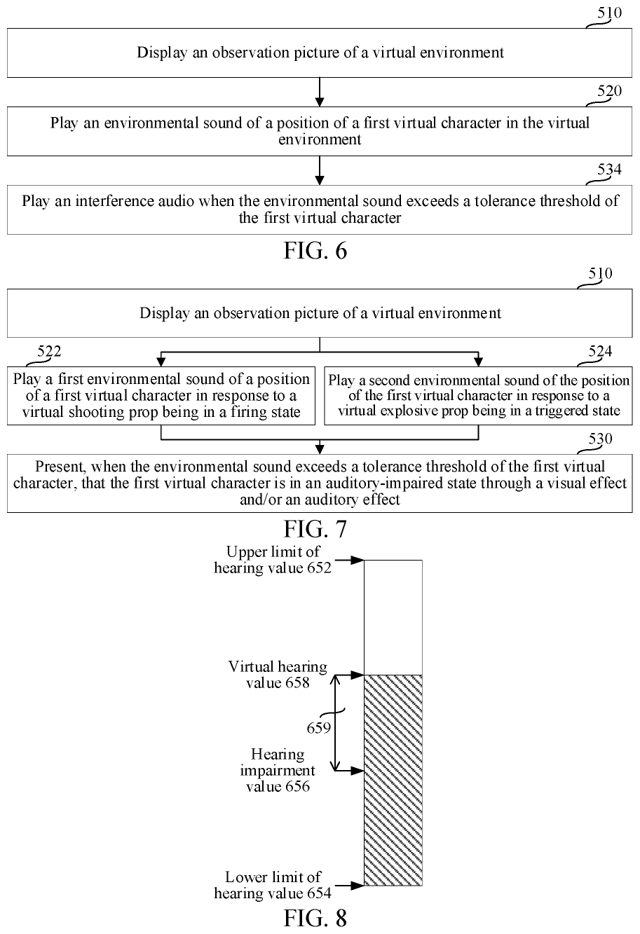

FIG. 6 is a flowchart of a human-machine interaction method for a virtual character according to an exemplary embodiment of this application. The method may be performed by a terminal. In other words, in the embodiment shown in FIG. 3, operation 530 may be implemented as operation 534.

Operation 534: Play an interference audio when the environmental sound exceeds a tolerance threshold of the first virtual character.

At a moment when the environmental sound exceeds the tolerance threshold of the first virtual character, the first virtual character is in an auditory-impaired state; the interference audio is a sound audio in a virtual environment that is obtained by the first virtual character that is in the auditory-impaired state; and the interference audio is an audio played by the first virtual character that is in the auditory-impaired state.

Audio quality of the interference audio is lower than audio quality of the environmental sound. The audio quality includes but is not limited to at least one of a sampling rate and an audio bit depth in the audio. Audio content of the interference audio is not limited in this embodiment. For example, as time goes by, virtual activities performed in the virtual environment are different, and corresponding sounds in the virtual environment are also different.

When the first virtual character is in the auditory-impaired state, the interference audio with low audio quality is played, to simulate a real-world state in which a perceptual capability declines after sound stimulation is received; and in the auditory-impaired state, information in the virtual environment that is obtained in an auditory manner is negatively affected.

In an exemplary implementation, the interference audio is described as follows, and operation 534 in this embodiment may be implemented as at least one of the following:
When the environmental sound exceeds the tolerance threshold of the first virtual character, replacing the environmental sound with a first interference audio.

The first interference audio is obtained by performing sound effect degradation on the environmental sound, and a sound effect degradation manner includes at least one of lowering a sampling rate, reducing an audio bit depth, and adding an echo; and a first interference sound is obtained by performing the sound effect degradation on the environmental sound, which reduces a clear degree of an original sound in the virtual environment, resulting in a case in which efficiency of obtaining the information in the virtual environment in the auditory manner is reduced.

In the sound effect degradation manner of lowering the sampling rate, an interval between two adjacent frames in the first interference audio is increased, resulting in a reduction in a fineness degree of sound sampling. In the sound effect degradation manner of reducing the audio bit depth, a dynamic range and precision of the first interference audio are reduced, resulting in a loss of detail information of the sound. The audio bit depth is configured for indicating sampling precision of an audio frame. In an example, the audio bit depth is 16 bits, which represents that audio information of an audio frame is represented by using a data space of 16 bits. In the sound effect degradation manner of adding the echo, the original sound in the virtual environment and the superimposed echo are caused to be interweaved with each other, resulting in a case in which difficulty in distinguishing the original sound in the virtual environment is increased.

The environmental sound is replaced with the first interference audio, to reduce the efficiency of obtaining the information in the virtual environment in the auditory manner. In this way, a real-world state in which a perceptual capability of a physiological organ declines after being stimulated by a sound is simulated.
When the environmental sound exceeds the tolerance threshold of the first virtual character, playing a second interference audio based on the current sound in a superimposed manner.

Exemplarily, the second interference audio is a noise audio. The noise audio is usually a sound whose audio amplitude and/or audio frequency is constant, for example, a buzzing sound, but a sound whose audio amplitude and/or audio frequency is in a periodic cycle is not excluded, for example, a buzzing sound or a breath sound with periodically fluctuating intensity.

Because the second interference audio is played based on the current sound in the superimposed manner, difficulty in distinguishing the original sound in the virtual environment is increased, and the efficiency of obtaining information in the virtual environment that is obtained in the auditory manner is reduced. In this way, a real-world state in which a perceptual capability of a physiological organ declines after being stimulated by a sound is simulated.

In an example, the current sound is the environmental sound in the virtual environment. In another example, the current sound is the first interference audio introduced above, that is, two implementations in this embodiment may be simultaneously performed.

In conclusion, in the method provided in this embodiment, when the environmental sound exceeds the tolerance threshold of the first virtual character, because the first virtual character is stimulated by the sound in the virtual environment and the sound exceeds a tolerance capability of the first virtual character, the first virtual character is in the auditory-impaired state. The auditory-impaired state is presented through a visual effect, and the terminal plays the interference audio to which the negative effect is applied, to reduce information quality presented in an auditory manner in a manner of superimposing noise or weakening the original sound in the virtual environment, so that the efficiency of obtaining the information in the virtual environment in the auditory manner is reduced. In this way, a real-world state in which a perceptual capability of a physiological organ declines after being stimulated by a sound can be simulated, thereby enhancing immersive feelings of the virtual environment.

In an exemplary design of this application, operation 532 in FIG. 4 may be combined with operation 534 in FIG. 6, operation 510, and operation 520 in FIG. 3 into a new embodiment, and the new embodiment is independently implemented. This application is not limited thereto.

In an exemplary design of this application, in the new embodiment in which the four operations (operation 510, operation 520, operation 532, and operation 534) described above are implemented in combination, the method further includes: obtaining volume information of the terminal, where the volume information of the terminal is configured for indicating a playing volume of the audio information on the terminal that performs a human-machine interaction method for a virtual character.

In an implementation, when the volume information of the terminal exceeds a volume threshold, referring to the description in operation 534, an interference audio is played when the environmental sound exceeds a tolerance threshold of the first virtual character.

When the volume information of the terminal exceeds the volume threshold, a user of the terminal obtains, through the audio information played by the terminal, information in the virtual environment in the auditory manner, and the interference audio is played to reduce quality of the information in the virtual environment that is obtained in the auditory manner, to simulate a real-world state in which a perceptual capability of a physiological organ declines after being stimulated by a sound in the same auditory sensory manner.

In another implementation, when the volume information of the terminal does not exceed the volume threshold, referring to the description in operation 532, the degraded picture of the virtual environment is displayed when the environmental sound exceeds the tolerance threshold of the first virtual character.

When the volume information of the terminal does not exceed the volume threshold, the user of the terminal obtains, through the audio information played by the terminal, the information in the virtual environment in the auditory manner. In this case, human-machine interaction efficiency is low, and consequently, the user of the terminal does not pay attention to the information in the virtual environment that is presented in the auditory manner. The degraded picture of the virtual environment is displayed, to simulate a real-world state in which a perceptual capability of a physiological organ declines after being stimulated by a sound in a visual manner, so as to simulate a state in which a visual observation is affected by vertigo after sound stimulation is received.

As introduced above, in the new embodiment in which operation 510, operation 520, operation 532, and operation 534 are implemented in combination, operation 532 and operation 534 may be performed simultaneously, and further, the volume information of the terminal is obtained. The playing volume of the interference audio is determined according to the volume information of the terminal. For example, the volume information of the terminal is determined as the playing volume of the interference audio. A degradation degree of the displayed degraded picture of the virtual environment is negatively correlated with the volume information of the terminal. As the volume information of the terminal is increased, the degradation degree of the degraded picture of the virtual environment is reduced. As the degradation degree of the degraded picture is decreased, a difference between the degraded picture and the observation picture of the virtual environment is reduced.

Next, an environmental sound of a virtual environment is described below: FIG. 7 is a flowchart of a human-machine interaction method for a virtual character according to an exemplary embodiment of this application. The method may be performed by a terminal. In other words, in the embodiment shown in FIG. 3, operation 520 may be implemented as at least one of operation 522 and operation 524.

Operation 522: Play a first environmental sound of a position of a first virtual character in response to a virtual shooting prop being in a firing state.

Referring to the description of operation 520 above, the environmental sound includes a sound of a virtual prop used by the first virtual character, and the use sound of the virtual prop is information in the virtual environment that is obtained in an auditory manner, and is also a source of auditory stimulation when a real-world state of a physiological organ after receiving external stimulation is simulated.

In this embodiment, the environmental sound is the first environmental sound, and the first environmental sound includes a firing sound effect of the virtual shooting prop. The virtual prop used in the virtual environment is the virtual shooting prop. This embodiment does not limit a user of the virtual shooting prop. The user of the virtual shooting prop may be the first virtual character, or another virtual character in the virtual environment; or the user of the virtual shooting prop may not exist, and the virtual shooting prop automatically enters in a firing state after the virtual character is discovered.

In this embodiment, the firing sound effect of the virtual shooting prop is propagated from a position of the virtual shooting prop as a start point, and an intensity of the firing sound effect is negatively correlated with a distance from the first virtual character to the position of the virtual shooting prop.

Exemplarily, when the intensity of the firing sound effect is less than a distinguish threshold, the firing sound effect is no longer played, that is, the firing sound effect of the virtual shooting prop cannot be obtained at the position of the first virtual character.

In some embodiments, the firing sound effect also includes a flying sound of a virtual bullet shot by the virtual shooting prop, which is configured for simulating a sound of friction between the bullet and air in the real world. Correspondingly, the intensity of the firing sound effect is a sum of intensities of a first sound effect and a second sound effect that are propagated from the position of the virtual shooting prop as the start point. The intensity of the second sound effect is negatively correlated with a distance between the first virtual character and a first ray. The first ray is a ray that starts at the position of the virtual shooting prop, and that propagates in a shooting direction of the virtual shooting prop.

Operation 524: Play a second environmental sound of the position of the first virtual character in response to a virtual explosive prop being in a triggered state.

In this embodiment, the second environmental sound includes an explosion sound effect of the virtual explosive prop. The virtual prop used in the virtual environment is the virtual explosive prop. Similar to operation 522, this embodiment does not limit a user of the virtual explosive prop. Exemplarily, the virtual explosive prop may be implemented as a prop directly carried by the virtual character, such as a virtual hand grenade, or may be implemented as a virtual prop operated by the virtual character, such as a virtual shell of a virtual artillery. This embodiment does not limit a type of the virtual explosive prop.

The explosion sound effect is not limited to being played only when the first virtual character is located in an effective range of the virtual explosive prop. Similar to the firing sound effect, the explosion sound effect is propagated from a position of the virtual explosive prop as a start point, and an intensity of the explosion sound effect is negatively correlated with a distance from the first virtual character to a trigger position of the virtual explosive prop. When the intensity of the explosion sound effect exceeds a distinguish threshold, the environmental sound including the explosion sound effect of the virtual explosive prop is played.

In an exemplary implementation, the environmental sound also includes a virtual activity sound of the virtual character. Based on the embodiment shown in FIG. 7, the method further includes at least one of the following:
Playing a third environmental sound in response to a second virtual character being virtually attacked.

In this implementation, the environmental sound includes the virtual activity sound of the virtual character, and the virtual activity sound is expanded to a source of auditory stimulation when a real-world state of a physiological organ after receiving external stimulation is simulated.

In this operation, the third environmental sound also includes a warning sound of the second virtual character. The warning sound of the second virtual character is played in response to the second virtual character being virtually attacked, and the warning sound can simulate a real-world stress response to an attack, which is shouting loudly as a warning. The played warning sound corresponds to an effect of high-intensity and sharp-sound auditory stimulation in the real world.

Exemplarily, sound content of the warning sound is usually a pronunciation of a preset text, for example, “Watch out, someone is attacking!”. Alternatively, the sound content of the warning sound may also be a pronunciation of a text obtained by filling a slot according to a direction of the virtual attack, for example, after being virtually attacked by a virtual hand grenade, a help-seeking sound is: “Watch out, a hand grenade hit me”, where the “hand grenade” is the text slot filled according to a type of the virtual attack.
Playing a fourth environmental sound in response to a third virtual character being in an injured state.

In this operation, the fourth environmental sound also includes a help-seeking sound of the third virtual character, and the help-seeking sound of the third virtual character is played in response to the third virtual character being in the injured state, and the help-seeking sound can simulate a real-world help-seeking response to the injured state, which is shouting loudly for help. The played help-seeking sound corresponds to an effect of high-intensity, and repetitive auditory stimulation in the real world.

Exemplarily, sound content of the help-seeking sound is usually a pronunciation of a preset text, for example, “Help! Help me, quickly!”. Alternatively, the sound content of the help-seeking sound may also be determined according to a specific condition of the injured state, for example, when the third virtual character is bruised, the help-seeking sound is “Help me, I need a bandage”, and when the third virtual character is injured by virtual magic, the help-seeking sound is “Help me, I need to get away from here”.

In another exemplary implementation, the environmental sound includes a virtual weather sound effect of the virtual environment. Based on the embodiment shown in FIG. 7, the method further includes:
Playing a fifth environmental sound in response to the virtual environment is in a first weather.

In this implementation, the fifth environmental sound further includes a weather sound effect of the first weather, and the virtual weather sound effect is expanded to a source of auditory stimulation when a real-world state of a physiological organ after receiving external stimulation is simulated.

Exemplarily, the first weather is usually severe weather (or referred to as extreme weather), such as heavy rainy weather, heavy wind weather, or thunder and lightning weather. Correspondingly, a virtual weather sound effect of the heavy rainy weather is a sound of dense rain drops, a virtual weather sound effect of the heavy wind weather is a blowing and howling sound of the wind, and a virtual weather sound effect of the thunder and lightning weather is a sound of lightning. The foregoing virtual weather sound effects can simulate auditory effects of weather in the real world, and effects of the virtual weather sound effects are long lasting and auditorily stimulative.

Next, a tolerance threshold of the first virtual character is described.

In an example, the environmental sound includes a sound of the virtual environment at a current moment. Correspondingly, the tolerance threshold of the first virtual character is implemented as a first threshold.

The environmental sounds described in the foregoing embodiments such as operation 530, operation 532, and operation 534 exceed the tolerance threshold of the first virtual character, which may be implemented as follows:
At the current moment, an instantaneous intensity of the environmental sound exceeds the first threshold.

When the environmental sound includes the sound of the virtual environment at the current moment, whether the environmental sound at the current moment exceeds the first threshold is only considered. When the instantaneous intensity of the environmental sound exceeds the first threshold, the first virtual character is in an auditory-impaired state. Whether the first virtual character is in the auditory-impaired state can be determined by using a relatively small amount of data at a single moment, so that a computing capability requirement of a terminal device is reduced, and computing resources are saved in a heavy load scenario in which the terminal needs to perform rendering of the virtual environment. Exemplarily, the current moment is system time of the terminal that displays the virtual environment.

In another example, the environmental sound includes a sound of the virtual environment at the current moment and a sound of the virtual environment at a historical moment. Correspondingly, the tolerance threshold of the first virtual character is implemented as a second threshold.

The environmental sounds described in the foregoing embodiments such as operation 530, operation 532, and operation 534 exceed the tolerance threshold of the first virtual character, which may be implemented as follows:
A first sum exceeds the second threshold, and the first sum is a sum of a sound intensity of the virtual environment at the current moment and a sound intensity of the virtual environment at a historical moment.

Exemplarily, when the environmental sound includes the sound of the virtual environment at the current moment and the sound of the virtual environment at a historical moment, the intensity of the environmental sound at a plurality of moments is considered, so that durability of a real-world negative effect, such as long-time tinnitus, that is generated by external stimulation on a physiological organ can be simulated.

The sound intensity of the virtual environment at the current moment and the sound intensity of the virtual environment at a historical moment exceed a third threshold, and the third threshold is less than the second threshold. The third threshold is configured for selecting a moment at which a virtual auditory sensation of the first virtual character is stimulated, to simulate a real-world case in which an auditory organ is not damaged by a common sound with low stimulation (for example, a sound of people talking), but is damaged by sound with high intensity and strong stimulation (for example, the roar of an airplane).

Duration between each historical moment of the at least one historical moment and the current moment is less than a duration threshold, for example, the duration is three seconds, and moments at which the virtual auditory sensation of the first virtual character is negatively affected are all located within three seconds before the current moment. The duration threshold is configured for indicating maximum lasting duration of the auditory-impaired state after the first virtual character leaves a position at which the sound intensity exceeds the third threshold at a moment. The auditory-impaired state is persistent, and does not immediately disappear after the first virtual character is away from the environmental sound with high intensity. To simulate the certain persistence of the auditory impairment in the real world, tinnitus lasts for a period of time after the first virtual character is away from the noise.

Exemplarily, a significance degree of a visual effect and/or an auditory effect is positively correlated with a degree to which the first sum exceeds the second threshold; referring to the foregoing descriptions, the terminal displays a degraded picture, and image quality of the degraded picture is decreased as the degree to which the first sum exceeds the second threshold is increased, for example, an amount of ghosting that exists on the degraded picture is increased and an area of a ghosting region is increased; the terminal plays an interference audio, and when the interference audio is a noise audio, a sound intensity of the interference audio is increased as the degree to which the first sum exceeds the second threshold is increased; and when the interference audio is an environmental sound on which degradation processing is performed, a degradation degree of the environmental sound is increased as the degree to which the first sum exceeds the second threshold is increased.

Further, based on this implementation, the second threshold is a difference obtained by subtracting a hearing impairment value from a virtual hearing value of the first virtual character at the current moment. The hearing impairment value is a dividing threshold for whether the first virtual character is in the auditory-impaired state, and is also referred to as a hearing threshold.

Correspondingly, based on the embodiment shown in FIG. 3, the method further includes: determining, when each of m differences is not greater than 0, a virtual hearing value at a current moment as a sum of a first historical hearing value and a hearing recovery value.

The first historical hearing value is a virtual hearing value at a first historical moment adjacent to the current moment. The hearing recovery value is usually preset. Exemplarily, when each of the m differences is not greater than 0, the virtual hearing value is increased according to the hearing recovery value at each moment.

The m differences are in a one-to-one correspondence with m information groups, and each information group in the m information groups includes historical hearing values at two adjacent historical moments.

The m information groups are constructed based on historical hearing values at m+1 historical moments; a 1^{st} information group is constructed based on two historical hearing values at a 1^{st} moment and a 2^{nd} moment based on the m+1 historical moments; a 2^{nd} information group is constructed based on two historical hearing values at the 2^{nd} moment and a 3^{rd} moment; an n^{th} information group is constructed based on two historical hearing values at an n^{th} moment and an (n+1)^{th} moment; and so on, the m information groups are constructed.

A difference corresponding to each information group is a difference obtained by subtracting a historical hearing value at a later moment from a historical hearing value at an earlier moment. As the foregoing 1^{st} information group, a corresponding difference is a difference obtained by subtracting the historical hearing value at the 2^{nd} moment from the historical hearing value at the 1^{st} moment.

When the difference corresponding to the information group is not greater than 0, at the later historical moment, the first virtual character is not stimulated by the environmental sound exceeding the third threshold, and the first virtual character is away from the environmental sound with high intensity. When each of the m differences is not greater than 0, the first virtual character continues to be away from the environmental sound with high intensity, and the hearing recovery value is added based on the first historical hearing value, to implement automatic recovery of the virtual hearing value. In some embodiments, as shown in FIG. 8, a virtual hearing value of a first virtual character has an upper limit of the hearing value 652 and a lower limit of the hearing value 654. A hearing impairment value 656 is a dividing threshold of whether the first virtual character is in an auditory-impaired state, and is located between the upper limit of the hearing value 652 and the lower limit of the hearing value 654. A virtual hearing value 658 is configured for indicating a virtual auditory capability of the first virtual character at a current moment. Referring to the foregoing descriptions, a second threshold 659 is a difference obtained by subtracting the hearing impairment value 656 from the virtual hearing value 658 of the first virtual character at the current moment.

When the virtual hearing value 658 of the first virtual character is recovered to the upper limit of the hearing value 652, a hearing recovery value is no longer increased; and when the virtual hearing value 658 of the first virtual character is decreased to the lower limit of the hearing value 654, the hearing recovery value is no longer decreased. A schematic diagram of the virtual hearing value shown in FIG. 8 may be displayed on a terminal, or may be merely used as an example for calculating the virtual hearing value, and is not displayed on a terminal.

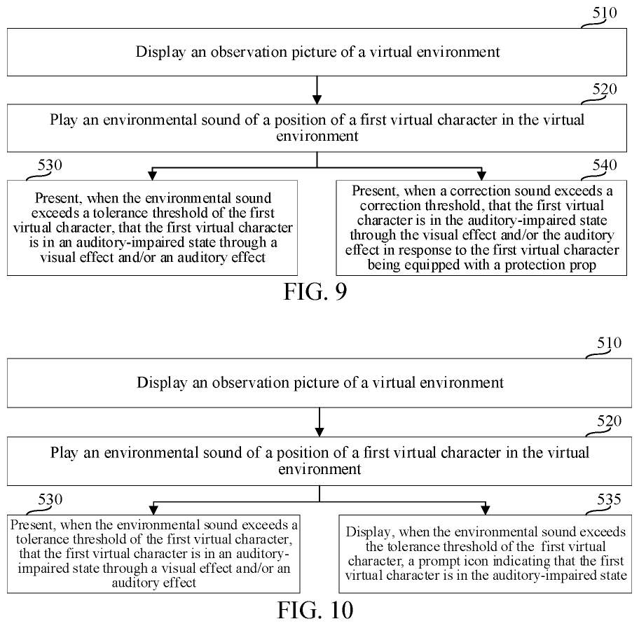

FIG. 9 is a flowchart of a human-machine interaction method for a virtual character according to an exemplary embodiment of this application. The method may be performed by a terminal. In other words, based on the embodiment shown on in FIG. 3, the method further includes operation 540.

Operation 540: Present, when a correction sound exceeds a correction threshold, that the first virtual character is in the auditory-impaired state through the visual effect and/or the auditory effect in response to the first virtual character being equipped with a protection prop.

Exemplarily, the protection prop is a wearable prop (such as a virtual earphone or a virtual noise reduction head cover) of the first virtual character, and/or a virtual accessory (such as a virtual muffler) of a virtual shooting prop. For descriptions of the auditory-impaired state, the visual effect, and the auditory effect, refer to the foregoing embodiments, and details are not repeated herein.

Exemplarily, a sound intensity of the correction sound is less than a sound intensity of the environmental sound, and/or a tolerance threshold exceeds the correction threshold. After the protection prop is equipped, compared with when the protection prop is not equipped, the sound intensity of the environmental sound is reduced; or whether the first virtual character is in the auditory-impaired state is determined through a looser correction threshold. Exemplarily, the looser threshold is configured for indicating the correction threshold that, compared with the tolerance threshold, a sound with stronger stimulation (for example, sound with higher sound intensity or longer sound lasting duration) is needed to exceed the correction threshold.

Exemplarily, in this embodiment, in operation 530, when the environmental sound exceeds the tolerance threshold of the first virtual character, that the first virtual character is in the auditory-impaired state is presented through the visual effect and/or the auditory effect, which is performed when the protection prop is not equipped.

In an exemplary implementation, before operation 535, the method further includes:
obtaining a correction coefficient corresponding to the protection prop in response to the first virtual character being equipped with the protection prop.

The protection prop has the corresponding correction coefficient, and the correction coefficient is configured for indicating a protection effect of the protection prop on an auditory sensation of the first virtual character. Using an example in which the environmental sound and/or the tolerance threshold are/is corrected by using the correction coefficient as a product, as the protection effect of protection prop on the first virtual character is increased, the correction coefficient is decreased.
Correcting the sound intensity of the environmental sound based on the correction coefficient, to obtain the correction sound; and/or, correcting the tolerance threshold based on the correction coefficient, to obtain the correction threshold.

Exemplarily, the environmental sound and/or tolerance threshold are/is corrected by using the correction coefficient as the product; and the sound intensity of the correction sound is obtained by calculating a product of the correction coefficient and the sound intensity of the environmental sound. The correction threshold is obtained by calculating a product of the correction coefficient and the tolerance threshold. At least one of the correction sound and the correction threshold can be implemented, and compared with a case in which the first virtual character is not equipped with the protection prop, the first virtual character that is equipped with the protection prop is less prone to be in the auditory-impaired state.

For the first virtual character equipped with the protection prop, when the virtual character is equipped with the wearable prop, all sound sources in the virtual environment are corrected by the correction coefficient. When the virtual accessory of the virtual shooting prop is equipped, a firing sound effect of the virtual shooting prop is corrected by the correction coefficient.

In conclusion, in the method provided in this embodiment, the protection prop configured for protecting the virtual auditory sensation of the first virtual character is provided, and the sound intensity of the environmental sound and/or the tolerance threshold can be corrected. Compared with a case in which the first virtual character is not equipped with the protection prop, the sound with stronger stimulation is needed to let the first virtual character that is equipped with the protection prop enter the auditory-impaired state. In this way, an implement in the real world that is configured to protect an auditory organ can be simulated, thereby enhancing immersive feelings of the virtual environment.

FIG. 10 is a flowchart of a human-machine interaction method for a virtual character according to an exemplary embodiment of this application. The method may be performed by a terminal. In other words, based on the embodiment shown on in FIG. 3, the method further includes operation 535.

Operation 535: Display, when the environmental sound exceeds the tolerance threshold of the first virtual character, a prompt icon indicating that the first virtual character is in the auditory-impaired state.

Exemplarily, the prompt icon is configured for indicating that the first virtual character is in the auditory-impaired state. As described above, the auditory-impaired state is presented through a visual effect and/or an auditory effect. In a virtual environment, scenarios in which a degraded picture is presented in a visual manner and an interference audio is played in an auditory manner are not limited to the auditory-impaired state.

For example, a virtual electronic device has an interference effect on a virtual earphone worn by the first virtual character; and when the first virtual character approaches the virtual electronic device, an electronic interference sound effect is played. The electronic interference sound effect is similar to the interference audio played in the auditory-impaired state. To indicate to a player that a current auditory effect is caused because the first virtual character is in the auditory-impaired state, the prompt icon indicating that the first virtual character is in the auditory-impaired state is displayed.

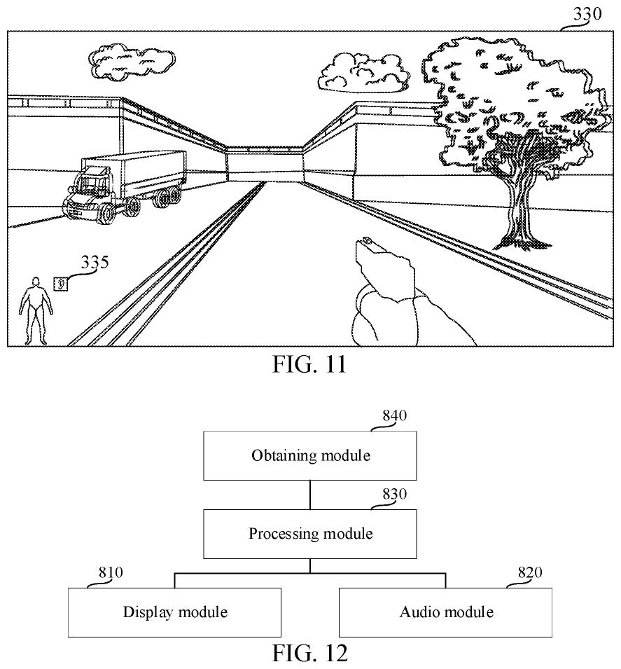

Exemplarily, the prompt icon is displayed on an observation picture of the virtual environment in a superposing manner when the first virtual character is in the auditory-impaired state. FIG. 11 is a schematic diagram of a virtual environment according to an exemplary embodiment of this application. A prompt icon 335 is displayed on a degraded picture 330 on which ghosting exists in a superimposed manner; and exemplarily, the prompt icon 335 includes an ear shape, to indicate, in a graphical manner, that the first virtual character is in an auditory-impaired state.

In conclusion, in the method provided in this embodiment, when environmental sound exceeds the tolerance threshold of the first virtual character, the first virtual character is in the auditory-impaired state, and the prompt icon indicating the auditory-impaired state is displayed, to indicate, in the graphical manner, that the first virtual character is in the auditory-impaired state, and to indicate to the player that a reason why the visual effect and/or the auditory effect are/is presented is that the first virtual character is in the auditory-impaired state, thereby improving efficiency of identifying, by the player, that the first virtual character is in the auditory-impaired state.

In an application scenario, an application program providing a virtual environment is a shooting game program, for example, the shooting game program is at least one of a battle royale shooting game, a TPS, and an FPS.
Displaying an observation picture of the virtual environment.

Exemplarily, the virtual environment provides a space for a plurality of virtual characters to perform a virtual competition. Exemplarily, the virtual character in the virtual environment attacks an enemy virtual character by firing a virtual shooting prop to implement the virtual competition. Exemplarily, a virtual building (such as a building or a garage) and a virtual obstacle (such as a stone or a box) are provided in the virtual environment, to provide masking for the virtual character. The virtual environment may further include a pickable virtual shooting prop, to be picked up and used by the virtual character.
Playing an environmental sound of the virtual environment.

The environmental sound includes a firing sound of the virtual shooting prop, and the virtual shooting prop may be carried by the first virtual character or another virtual character in the virtual environment, or may be deployed in the virtual environment for automatic use.
When the environmental sound exceeds a tolerance threshold of the first virtual character, changing the first virtual character from an auditory-normal state to an auditory-impaired state.

When the environmental sound exceeds the tolerance threshold of the first virtual character, the first virtual character is stimulated by the firing sound of the virtual shooting prop included in the environmental sound, and the stimulation of the foregoing firing sound exceeds a tolerance capability of the first virtual character, causing the first virtual character to be in the auditory-impaired state. Exemplarily, the auditory-impaired state is presented through the visual effect, and a degraded picture of the virtual environment is displayed. The degraded picture is an observation result of the virtual environment by the first virtual character that is in the auditory-impaired state.

Ghosting exists on a virtual item in the degraded picture, and the ghosting and the virtual item in the degraded picture overlap with each other, increasing difficulty in determining, by an observer of the degraded picture, an edge position of the virtual item, and difficulty in observing, by the observer of the degraded picture, a detailed feature of the virtual item, so that an observation effect of the virtual environment by the first virtual character is reduced. In this way, a real-world state in which a perceptual capability of a physiological organ declines after being stimulated by a sound is simulated. In the auditory-impaired state, information in the virtual environment that is obtained in a visual observation manner is negatively affected.

Exemplarily, an interference audio is played, to present the auditory-impaired state through the auditory effect. The interference audio is an audio played by the first virtual character in the auditory-impaired state. The interference audio is a noise audio, for example, a buzzing sound.

A current sound is an environmental sound in a virtual environment at a current moment when the first virtual character is in the auditory-impaired state. The interference audio is played based on the current sound in a superimposed manner, so that difficulty in distinguishing an original sound in the virtual environment is increased, and efficiency of obtaining the information in the virtual environment in the auditory manner is reduced. In this way, a real-world state in which a perceptual capability of a physiological organ declines after being stimulated by a sound is simulated. In the auditory-impaired state, the information in the virtual environment that is obtained in the auditory manner is negatively affected.

A person of ordinary skill in the art may understand that, the foregoing embodiments may be independently implemented, or the foregoing embodiments may be freely combined to obtain new embodiments, to implement a human-machine interaction method for a virtual character of this application.

FIG. 12 is a block diagram of a structure of a human-machine interaction apparatus for a virtual character according to an exemplary embodiment of this application. The apparatus includes: a display module 810, configured to perform operation 510 in the embodiment corresponding to FIG. 3; and an audio module 820, configured to perform operation 520 in the embodiment corresponding to FIG. 3, an environmental sound including a sound of a virtual prop used by the first virtual character, the display module 810 being further configured to present, when the environmental sound exceeds a tolerance threshold of a first virtual character, that the first virtual character is in an auditory-impaired state through a visual effect; and/or the audio module 820 being further configured to present, when the environmental sound exceeds the tolerance threshold of the first virtual character, that the first virtual character is in the auditory-impaired state through an auditory effect.

In an exemplary implementation of this embodiment, the display module 810 is further configured to perform operation 532 in the embodiment corresponding to FIG. 4; and a degraded picture is an observation result of the virtual environment by the first virtual character that is in the auditory-impaired state, and image quality of the degraded picture is lower than image quality of the observation picture.

In an exemplary implementation of this embodiment, the display module 810 is further configured to perform at least one of the following: display that a first region of the degraded picture is blocked; display that ghosting exists on a virtual item located in a second region of the degraded picture; display that a third region of the degraded picture is superimposed with a first color; display a blur effect in a fourth region of the degraded picture; and display the degraded picture at a first resolution, the first resolution being lower than a second resolution of the observation picture.

In an exemplary implementation of this embodiment, the audio module 820 is further configured to perform operation 534 in the embodiment corresponding to FIG. 6; and an interference audio is an audio played by the first virtual character that is in the auditory-impaired state, and audio quality of the interference audio is lower than audio quality of the environmental sound.

In an exemplary implementation of this embodiment, the audio module 820 is further configured to perform at least one of the following: replace the environmental sound with a first interference audio when the environmental sound exceeds the tolerance threshold of the first virtual character, the first interference audio being obtained by performing sound effect degradation on the environmental sound, and a sound effect degradation manner including at least one of lowering a sampling rate, reducing an audio bit depth, and adding an echo; and play a second interference audio based on a current sound in a superimposed manner when the environmental sound exceeds the tolerance threshold of the first virtual character, the second interference audio being a noise audio.

In an exemplary implementation of this embodiment, the environmental sound includes a sound of the virtual environment at the current moment, and that the environmental sound exceeds the tolerance threshold of the first virtual character includes: at the current moment, an instantaneous intensity of the environmental sound exceeds a first threshold.

In an exemplary implementation of this embodiment, the environmental sound includes a sound of the virtual environment at the current moment and a sound of the virtual environment at a historical moment, and that the environmental sound exceeds the tolerance threshold of the first virtual character includes: a first sum exceeds a second threshold, the first sum being a sum of a sound intensity of the virtual environment at the current moment and a sound intensity of the virtual environment at a historical moment, and the sound intensity of the virtual environment at the current moment and the sound intensity of the virtual environment at a historical moment exceeding a third threshold, and the third threshold being less than the second threshold, and duration between each historical moment of the at least one historical moment and the current moment being less than a duration threshold.

In an exemplary implementation of this embodiment, the second threshold is a difference obtained by subtracting a hearing impairment value from a virtual hearing value of the first virtual character at the current moment; and the apparatus further includes: a processing module 830, configured to: determine, when each of m differences is not greater than 0, the virtual hearing value at the current moment as a sum of a first historical hearing value and a hearing recovery value, the first historical hearing value being a virtual hearing value at a first historical moment adjacent to the current moment, the m differences being in a one-to-one correspondence with m information groups, each information group in the m information groups including historical hearing values of two adjacent historical moments, the m information groups being constructed based on historical hearing values of m+1 historical moments, and a difference corresponding to each information group being a difference obtained by subtracting a historical hearing value at a later moment from a historical hearing value at an earlier moment.

In an exemplary implementation of this embodiment, the audio module 820 is further configured to perform at least one of the following: play a first environmental sound of a position of the first virtual character in response to a virtual shooting prop being in a firing state, the first environmental sound including a firing sound effect of the virtual shooting prop; and play a second environmental sound of the position of the first virtual character in response to a virtual explosive prop being in a triggered state, the second environmental sound including an explosion sound effect of the virtual explosive prop.

In an exemplary implementation of this embodiment, the environmental sound also includes a virtual activity sound of the virtual character, and the audio module 820 is further configured to perform at least one of the following: play a third environmental sound in response to a second virtual character being virtually attacked, the third environmental sound also including a warning sound of the second virtual character; and play a fourth environmental sound in response to a third virtual character being in an injured state, the fourth environmental sound further including a help-seeking sound of the third virtual character. In an exemplary implementation of this embodiment, the environmental sound includes a virtual weather sound effect of the virtual environment, and the audio module 820 is further configured to: play a fifth environmental sound in response to the virtual environment being in a first weather, the fifth environmental sound further including a weather sound effect of the first weather.

In an exemplary implementation of this embodiment, the apparatus further includes: the display module 810, further configured to: present, when a correction sound exceeds a correction threshold, that the first virtual character is in the auditory-impaired state through the visual effect in response to the first virtual character being equipped with a protection prop; and/or the audio module 820, further configured to present, when the correction sound exceeds the correction threshold, that the first virtual character is in the auditory-impaired state through the auditory effect, the protection prop being a wearing prop of the first virtual character and/or a virtual accessory of the virtual shooting prop, and a sound intensity of the correction sound being less than a sound intensity of the environmental sound, and/or the tolerance threshold exceeding the correction threshold.

In an exemplary implementation of this embodiment, the apparatus further includes: an obtaining module 840, configured to: obtain a correction coefficient corresponding to the protection prop in response to the first virtual character being equipped with the protection prop; and a processing module 830, configured to correct the sound intensity of the environmental sound based on the correction coefficient, to obtain the sound intensity of the correction sound; and/or, correct the tolerance threshold based on the correction coefficient, to obtain the correction threshold.

In an exemplary implementation of this embodiment, the display module 810 is further configured to perform operation 535 in the embodiment corresponding to FIG. 10.

When the apparatus provided in the foregoing embodiments implements functions of the apparatus, division of the foregoing various functional modules is merely used as an example for description. In an actual application, the function distribution may be finished by different functional modules according to actual requirements, that is, a content structure of a device is divided into different functional modules, so as to complete all or some of the functions described above.

Specific manners of performing operations by the modules of the apparatus in the foregoing embodiment have been described in detail in the embodiments related to the method. Technical effects obtained by performing the operations by the modules are the same as the technical effects in the embodiments related to the method, and details are not described herein again.

An embodiment of this application further provides a computer device, and the computer device includes: a processor and a memory, where the memory has a computer program stored therein, and the processor is configured to perform the computer program stored in the memory, to implement a human-machine interaction method for a virtual character according to the method embodiments described above.

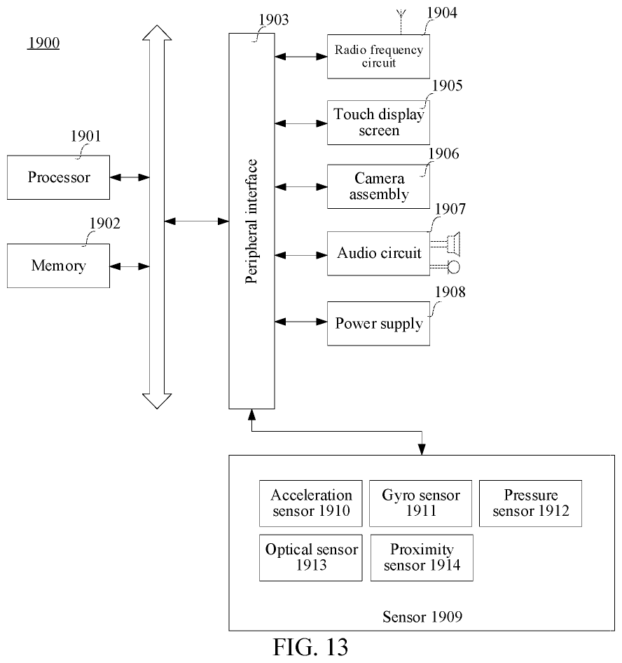

FIG. 13 is a block diagram of a structure of a terminal according to an exemplary embodiment of this application. The terminal 1900 may be: a smartphone, a tablet computer, a moving picture experts group audio layer III (MP3) player, a moving picture experts group audio layer IV (MP4) player, a notebook computer, or a desktop computer. The terminal 1900 may alternatively be referred to as a user equipment, a portable terminal, a laptop terminal, a desktop terminal, or other names.

Generally, the terminal 1900 includes: a processor 1901 and a memory 1902. The processor 1901 may include one or more processing cores, for example, a 4-core processor and an 8-core processor. The processor 1901 may be implemented by using at least one hardware form of a digital signal processing (DSP), a field-programmable gate array (FPGA), and a programmable logic array (PLA). The processor 1901 may also include a main processor and a coprocessor. The main processor is a processor configured to process data in an active state, also referred to as a central processing unit (CPU). The coprocessor is a low-power consumption processor configured to process data in a standby state. In some embodiments, the processor 1901 may be integrated with a graphics processing unit (GPU). The GPU is configured to render and draw content that needs to be displayed on a display screen. In some embodiments, the processor 1901 may further include an artificial intelligence (AI) processor. The AI processor is configured to process computing operations related to machine learning.

The memory 1902 may include one or more computer-readable storage media. The computer-readable storage media may be non-transitory. The memory 1902 may alternatively include a high-speed random access memory and a non-volatile memory, for example, one or more disk storage devices and flash storage devices. In some embodiments, the non-transitory computer-readable storage medium in the memory 1902 is configured to store at least one instruction. The at least one instruction is configured for being executed by the processor 1901 to perform a human-machine interaction method for a virtual character provided in the method embodiments of this application.

In some embodiments, the terminal 1900 may further selectively include: a peripheral interface 1903 and at least one peripheral. The processor 1901, the memory 1902, and the peripheral interface 1903 may be connected by using a bus or a signal cable. Each peripheral may be connected to the peripheral interface 1903 through a bus, a signal cable, or a circuit board. For example, the peripheral includes: at least one of a radio frequency circuit 1904, a touch display screen 1905, a camera assembly 1906, an audio circuit 1907, and a power supply 1908. The peripheral interface 1903 may be configured to connect at least one peripheral related to input/output (I/O) to the processor 1901 and the memory 1902. In some embodiments, the processor 1901, the memory 1902, and the peripheral interface 1903 are integrated on a same chip or a circuit board. In some other embodiments, any one or two of the processor 1901, the memory 1902, and the peripheral interface 1903 may be implemented on an independent chip or circuit board. This is not limited in this embodiment.

The radio frequency circuit 1904 is configured to receive and transmit a radio frequency (RF) signal, which is also referred to as an electromagnetic signal. The radio frequency circuit 1904 communicates with a communication network and another communication device through the electromagnetic signal. The radio frequency circuit 1904 may further include a circuit related to near field communication (NFC). The touch display screen 1905 is configured to display a user interface (UI). The UI may include a graph, a text, an icon, a video, or any combination thereof. The camera assembly 1906 is configured to collect an image or a video. In some embodiments, the camera assembly 1906 includes a front-facing camera and a rear-facing camera. The audio circuit 1907 may include a microphone and a speaker. The microphone is configured to collect sound waves of a user and an environment, and convert the sound waves into electrical signals and input the electrical signals to the processor 1901 for processing, or input the electrical signals to the radio frequency circuit 1904 to implement voice communication. The power supply 1908 is configured to supply power to components in the terminal 1900. The power supply 1908 may be an alternating current, a direct current, a disposable battery, or a rechargeable battery.

In some embodiments, the terminal 1900 further includes one or more sensors 1909. The one or more sensors 1909 include, but are not limited to, an acceleration sensor 1910, a gyro sensor 1911, a pressure sensor 1912, an optical sensor 1913, and a proximity sensor 1914. The acceleration sensor 1910 may detect a magnitude of acceleration on three coordinate axes of a coordinate system established by the terminal 1900. The pressure sensor 1912 may be arranged on a side frame of the terminal 1900 and/or a lower layer of the touch display screen 1905. The pressure sensor 1912 detects a holding signal of a user on the terminal 1900, and/or, controls an operable control on the UI interface based on a pressure operation by the user on the touch display screen 1905. The optical sensor 1913 is configured to collect an ambient light intensity. The proximity sensor 1914, also referred to as a distance sensor, is usually arranged on a front panel of the terminal 1900. The proximity sensor 1914 is configured to collect a distance between the user and a front face of the terminal 1900.

A person skilled in the art may understand that, the foregoing structures constitute no limitation on the terminal 1900, and the terminal 1900 may include more or fewer components than those shown in the figure, or some components may be combined, or a different component arrangement may be used.

In an exemplary embodiment, a chip is further provided. The chip includes a programmable logic circuit and/or a program instruction, and when the chip runs on a computer device, the chip is configured to implement a human-machine interaction method for a virtual character according to the foregoing aspects. In an exemplary embodiment, a computer program product is further provided. The computer program product includes computer instructions, and the computer instructions are stored in a computer-readable storage medium. A processor of the computer device reads the computer instructions from the computer-readable storage medium, and the processor reads and executes the computer instructions from the computer-readable storage medium, to implement a human-machine interaction method for a virtual character provided in the foregoing method embodiments.

In an exemplary embodiment, a computer-readable storage medium is further provided, the computer-readable storage medium having a computer program stored herein, and the computer program being loaded and executed by a processor to implement a human-machine interaction method for a virtual character provided in the foregoing method embodiments.

A person skilled in the art may understand that all or some of the operations of the foregoing embodiments may be implemented by hardware, or may be implemented by a program instructing relevant hardware. The program may be stored in a computer-readable storage medium. The above-mentioned storage medium may be a read-only memory, a magnetic disk, an optical disc, or the like. A person skilled in the art is to be aware that in the one or more examples, the functions described in the embodiments of this application may be implemented by using hardware, software, firmware, or any combination thereof. When these functions are implemented by the software, the functions may be stored in a computer-readable medium or transmitted as one or more instructions or code on the computer-readable medium. The computer readable medium includes a computer storage medium and a communication medium, where the communication medium includes any medium that facilitates the transfer of a computer program from one place to another. The storage medium may be any available medium accessible to a general-purpose or dedicated computer.

What is claimed is:

1. A human-machine interaction method performed by a computer device, and the method comprising:
displaying an observation picture of a virtual environment;
playing an environmental sound of a position of a first virtual character in the virtual environment, the environmental sound comprising a sound of a virtual prop used by the first virtual character;
when the environmental sound exceeds a tolerance threshold of the first virtual character, changing the first virtual character from an auditory-normal state to an auditory-impaired state; and
displaying a degraded picture of the virtual environment, the degraded picture being an observation result of the virtual environment by the first virtual character that is in the auditory-impaired state, and image quality of the degraded picture being lower than image quality of the observation picture.

2. The method according to claim 1, wherein the displaying a degraded picture of the virtual environment comprises at least one of the following:
displaying that a first region of the degraded picture is blocked;
displaying that ghosting exists on a virtual item located in a second region of the degraded picture;
displaying that a third region of the degraded picture is superimposed with a first color;
displaying a blur effect in a fourth region of the degraded picture; and
displaying the degraded picture at a first resolution, the first resolution being lower than a second resolution of the observation picture.

3. The method according to claim 1, wherein the method further comprises:
playing an interference audio when the environmental sound exceeds the tolerance threshold of the first virtual character, the interference audio being an audio played by the first virtual character that is in the auditory-impaired state, and audio quality of the interference audio being lower than audio quality of the environmental sound.

4. The method according to claim 3, wherein the playing an interference audio when the environmental sound exceeds the tolerance threshold of the first virtual character comprises at least one of the following:
performing sound effect degradation on the environmental sound by at least one of lowering a sampling rate, reducing an audio bit depth, and adding an echo to obtain a first interference audio;
replacing the environmental sound with the first interference audio; and
superimposing the first interference audio with a second interference audio based on the current sound, the second interference audio being a noise audio.

5. The method according to claim 1, wherein the environmental sound exceeds the tolerance threshold of the first virtual character when a current instantaneous intensity of the environmental sound exceeds a first threshold.

6. The method according to claim 1, wherein the environmental sound exceeds the tolerance threshold of the first virtual character when a sum of a current sound intensity of the virtual environment and a historical sound intensity of the virtual environment exceeds a second threshold.

7. The method according to claim 6, wherein the second threshold is a difference obtained by subtracting a hearing impairment value from a virtual hearing value of the first virtual character at the current moment; and the method further comprises:
determining, when each of m differences is not greater than 0, the virtual hearing value at the current moment as a sum of a first historical hearing value and a hearing recovery value, the first historical hearing value being a virtual hearing value at a first historical moment adjacent to the current moment,
the m differences being in a one-to-one correspondence with m information groups, each information group in the m information groups comprising historical hearing values of two adjacent historical moments, the m information groups being constructed based on historical hearing values of m+1 historical moments, and a difference corresponding to each information group being a difference obtained by subtracting a historical hearing value at a later moment from a historical hearing value at an earlier moment.

8. The method according to claim 1, wherein the playing an environmental sound of a position of a first virtual character in the virtual environment comprises at least one of the following:
playing a first environmental sound of the position of the first virtual character in response to a virtual shooting prop being in a firing state, the first environmental sound comprising a firing sound effect of the virtual shooting prop; and
playing a second environmental sound of the position of the first virtual character in response to a virtual explosive prop being in a triggered state, the second environmental sound comprising an explosion sound effect of the virtual explosive prop.

9. The method according to claim 8, wherein the environmental sound further comprises a virtual activity sound of the virtual character, and the method further comprises at least one of the following:
playing a third environmental sound in response to a second virtual character being virtually attacked, the third environmental sound further comprising a warning sound of the second virtual character; and
playing a fourth environmental sound in response to a third virtual character being in an injured state, the fourth environmental sound further comprising a help-seeking sound of the third virtual character.

10. The method according to claim 1, wherein the method further comprises:
displaying a prompt icon indicating that the first virtual character is in the auditory-impaired state when the environmental sound exceeds the tolerance threshold of the first virtual character.

11. A computer device comprising: a processor and a memory, the memory having at least one program stored therein; and the processor being configured to execute the at least one program in the memory, to implement a human-machine interaction method including:
displaying an observation picture of a virtual environment;
playing an environmental sound of a position of a first virtual character in the virtual environment, the environmental sound comprising a sound of a virtual prop used by the first virtual character;
when the environmental sound exceeds a tolerance threshold of the first virtual character, changing the first virtual character from an auditory-normal state to an auditory-impaired state; and
displaying a degraded picture of the virtual environment, the degraded picture being an observation result of the virtual environment by the first virtual character that is in the auditory-impaired state, and image quality of the degraded picture being lower than image quality of the observation picture.

12. The computer device according to claim 11, wherein the displaying a degraded picture of the virtual environment comprises at least one of the following:
displaying that a first region of the degraded picture is blocked;
displaying that ghosting exists on a virtual item located in a second region of the degraded picture;
displaying that a third region of the degraded picture is superimposed with a first color;
displaying a blur effect in a fourth region of the degraded picture; and
displaying the degraded picture at a first resolution, the first resolution being lower than a second resolution of the observation picture.

13. The computer device according to claim 11, wherein the method further comprises:
playing an interference audio when the environmental sound exceeds the tolerance threshold of the first virtual character, the interference audio being an audio played by the first virtual character that is in the auditory-impaired state, and audio quality of the interference audio being lower than audio quality of the environmental sound.

14. The computer device according to claim 13, wherein the playing an interference audio when the environmental sound exceeds the tolerance threshold of the first virtual character comprises at least one of the following:
performing sound effect degradation on the environmental sound by at least one of lowering a sampling rate, reducing an audio bit depth, and adding an echo to obtain a first interference audio;
replacing the environmental sound with the first interference audio; and
superimposing the first interference audio with a second interference audio based on the current sound, the second interference audio being a noise audio.

15. The computer device according to claim 11, wherein the environmental sound exceeds the tolerance threshold of the first virtual character when a current instantaneous intensity of the environmental sound exceeds a first threshold.

16. The computer device according to claim 11, wherein the environmental sound exceeds the tolerance threshold of the first virtual character when a sum of a current sound intensity of the virtual environment and a historical sound intensity of the virtual environment exceeds a second threshold.

17. The computer device according to claim 16, wherein the second threshold is a difference obtained by subtracting a hearing impairment value from a virtual hearing value of the first virtual character at the current moment; and the method further comprises:
determining, when each of m differences is not greater than 0, the virtual hearing value at the current moment as a sum of a first historical hearing value and a hearing recovery value, the first historical hearing value being a virtual hearing value at a first historical moment adjacent to the current moment,
the m differences being in a one-to-one correspondence with m information groups, each information group in the m information groups comprising historical hearing values of two adjacent historical moments, the m information groups being constructed based on historical hearing values of m+1 historical moments, and a difference corresponding to each information group being a difference obtained by subtracting a historical hearing value at a later moment from a historical hearing value at an earlier moment.

18. The computer device according to claim 11, wherein the playing an environmental sound of a position of a first virtual character in the virtual environment comprises at least one of the following:
playing a first environmental sound of the position of the first virtual character in response to a virtual shooting prop being in a firing state, the first environmental sound comprising a firing sound effect of the virtual shooting prop; and
playing a second environmental sound of the position of the first virtual character in response to a virtual explosive prop being in a triggered state, the second environmental sound comprising an explosion sound effect of the virtual explosive prop.

19. The computer device according to claim 18, wherein the environmental sound further comprises a virtual activity sound of the virtual character, and the method further comprises at least one of the following:
playing a third environmental sound in response to a second virtual character being virtually attacked, the third environmental sound further comprising a warning sound of the second virtual character; and
playing a fourth environmental sound in response to a third virtual character being in an injured state, the fourth environmental sound further comprising a help-seeking sound of the third virtual character.

20. A non-transitory computer-readable storage medium having executable instructions stored therein, and the executable instructions being loaded and executed by a processor of a computer device, to implement a human-machine interaction method including:
displaying an observation picture of a virtual environment;
playing an environmental sound of a position of a first virtual character in the virtual environment, the environmental sound comprising a sound of a virtual prop used by the first virtual character;
when the environmental sound exceeds a tolerance threshold of the first virtual character, changing the first virtual character from an auditory-normal state to an auditory-impaired state; and
displaying a degraded picture of the virtual environment, the degraded picture being an observation result of the virtual environment by the first virtual character that is in the auditory-impaired state, and image quality of the degraded picture being lower than image quality of the observation picture.
